(19) United States
(12) Patent Application Publication
(10) Pub. No.: US 2025/0138448 A1
(43) Pub. Date: May 1, 2025

(54) IMAGE FORMING APPARATUS

(71) Applicant: CANON KABUSHIKI KAISHA, Tokyo (JP)

(72) Inventor: MASAKI HIROSE, Kanagawa (JP)

(21) Appl. No.: 18/885,170

(22) Filed: Sep. 13, 2024

(30) Foreign Application Priority Data
Oct. 26, 2023 (JP) 2023-183782

(51) Int. Cl. G03G 15/043; G03G 15/04

(52) U.S. Cl. CPC G03G 15/043; G03G 15/04072; G03G 15/0409; G03G 2215/0404

(57) ABSTRACT

An image forming apparatus includes a photosensitive drum, an optical scanning device and a controller. The optical scanning device forms a latent image on the photosensitive drum by scanning laser light based on image data in a scanning direction. The controller corrects the image data. In the image forming apparatus, a scanning speed which is a speed of the laser light scanned on the photosensitive member is slower at a center portion than at an end portion. The controller corrects the image data according to a continuous pixel number which is a number of pixels, for forming the latent image, continued in the scanning direction and a pixel position which is a position within continuous pixels which are a plurality of pixels continued.

### FIELD OF THE INVENTION AND RELATED ART

The present invention relates to an image forming apparatus, and in the image forming apparatus, for example, such as a laser beam printer, a digital copy machine and a digital facsimile, relates to the image forming apparatus which performs writing with light using a laser beam.

The image forming apparatus of electrophotographic type includes an optical scanning unit for exposing a photosensitive member. The optical scanning unit emits a laser light based on image data, and the laser light is reflected by a rotating polygon mirror and is allowed to transmit through a scanning lens to irradiate and expose the photosensitive member. By performing a scanning in which a spot of the laser light formed on a surface of the photosensitive member is moved by rotating the polygon mirror, a latent image is formed on the photosensitive member. The scanning lens is a lens having a so-called fθ characteristic.

The fθ characteristic is an optical characteristic which causes the laser light to form an image on the surface of the photosensitive member so that the spot of the laser light on the surface of the photosensitive member is moved at a constant speed when the rotating polygon mirror is rotated at a constant angular speed. By using the scanning lens having the fθ characteristic in this manner, appropriate exposure can be performed.

The scanning lens having such fθ characteristic is, however, relatively large and costly. Therefore, for purposes of downsizing and cost reduction of the image forming apparatus, it is considered to use no scanning lens itself or to use the scanning lens which does not have the fθ characteristic. For example, in Japanese Patent Application Laid-Open No. S58-125064, it is disclosed that an electrical correction is performed to change an image clock frequency during performing one scanning so that pixels formed on the surface of the photosensitive member are disposed evenly, even in a case in which the spot of the laser light on the surface of the photosensitive member is not moved at a constant speed.

However, even if the scanning lens having fθ characteristic is not used and the width of each pixel is regulated by the electrical correction as described above, the moving speed on the surface of the photosensitive member varies. Specifically, the moving speeds of the spot of the laser light on the surface of the photosensitive member to form one pixel are different for one pixel at an end portion and one pixel at a center portion in a main scanning direction. Therefore, exposure amounts per unit area are different between the pixel at the end portion and the pixel at the center portion in the main scanning direction. Examples of problems which occur because the exposure amounts at the center portion and at the end portion are different include a difference in widths of toner images (image widths) formed on the photosensitive member. Since the exposure amount at the center portion is more than that at the end portion, a thicker latent image is formed on the photosensitive member at the center portion, an image width becomes thicker as well at the center portion. In particular, this tendency is noticeable upon attempting to print thin vertical lines.

The present invention is conceived under such a situation, and an object of the present invention is to reduce a difference in image widths in a scanning direction of a laser even in a case in which a lens having fθ characteristic is not used.

### SUMMARY OF THE INVENTION

In order to solve the aforementioned problems, the present invention is provided with the following configuration.

An image forming apparatus comprising: a rotatable photosensitive member; and a light emitting means configured to form a latent image on the photosensitive member by scanning laser light based on image data in a scanning direction, wherein a scanning speed which is a speed of the laser light scanned on the photosensitive member is slower at a center portion than at an end portion, and a correcting means configured to correct the image data according to a continuous pixel number which is a number of pixels, for forming the latent image, continued in the scanning direction and a pixel position which is a position within continuous pixels which are a plurality of pixels continued.

According to the present invention, difference in image widths in a scanning direction of a laser can be reduced even in a case in which a lens having fθ characteristic is not used.

Further features of the present invention will become apparent from the following description of exemplary embodiments with reference to the attached drawings.

### BRIEF DESCRIPTION OF THE DRAWINGS

FIG. 1 is a schematic view of a configuration of a main portion of an image forming apparatus in Embodiments 1 through 3.

FIG. 2, part (a) and part (b), includes a main scanning cross-sectional view and a sub scanning cross-sectional view of an optical scanning device in the Embodiments 1 through 3.

FIG. 3 is a graph of a characteristic of partial magnification with respect to an image height of the optical scanning device in the Embodiments 1 through 3.

FIG. 4 is an electrical block diagram illustrating a configuration for an exposure control in the Embodiments 1 through 3.

FIG. 5, part (a) and part (b), is a view illustrating a time chart and a dot image of each signal in the Embodiments 1 through 3.

FIG. 6 is a block diagram illustrating an image modulating portion in the Embodiments 1 through 3.

FIG. 7, part (a) and part (b), includes a view illustrating an example of a screen and a view describing a pixel and a pixel piece in the Embodiments 1 through 3.

FIG. 8 is a time chart related to an operation of the image modulating portion in the Embodiments 1 through 3.

FIG. 9, part (a), part (b) and part (c), includes a view illustrating an example of an image signal input to a halftone processing portion, a view illustrating the screen, and an example of the screen to which a halftone process is applied in the Embodiments 1 through 3.

FIG. 10, part (a) and part (b), is a view describing an insertion and a removal of the pixel pieces in the Embodiments 1 through 3.

FIG. 11 is a view describing partial magnification correction by clock frequency correction in the Embodiments 1 through 3.

FIG. 12, part (a) and part (b), is a view describing image widths formed at a center portion and at an end portion in a print area in the Embodiments 1 through 3.

FIG. 13, part (a), part (b) and part (c), is a view describing effect from a light quantity of a laser on a formation of an electrostatic latent image in the Embodiments 1 through 3.

FIG. 14, part (a) and part (b), is a view describing shortening a pixel width of an outermost pixel in the Embodiments 1 through 3.

FIG. 15 is a view describing effect from an image width correcting process on the image width in the Embodiments 1 through 3.

FIG. 16 is a flowchart illustrating a method for the image width correcting process in the Embodiment 1.

FIG. 17 is a view describing effect in the Embodiment 1.

FIG. 18, part (a) and part (b), includes a view describing a difference in sensitivity of photosensitive drums in the Embodiment 2, and a view describing effect therefrom on regularity of the image width in a scanning direction.

FIG. 19 is a flowchart illustrating a method for an image width correcting process in the Embodiment 2.

FIG. 20 is a flowchart illustrating a method for an image width correcting process in the Embodiment 3.

### DESCRIPTION OF THE EMBODIMENTS

Hereinafter, with reference to the drawings, modes for implementing the present invention will be exemplarily described in detail based on Embodiments. However, dimensions, material and shapes of components, relative arrangement thereof, etc. described in the Embodiments are what may be changed appropriately according to configurations of an apparatus and various conditions to which the present invention is applied. In other words, it is not intended to limit a scope of the present invention to the modes of implementation described below.

### Embodiment 1

### (1) Image Forming Apparatus

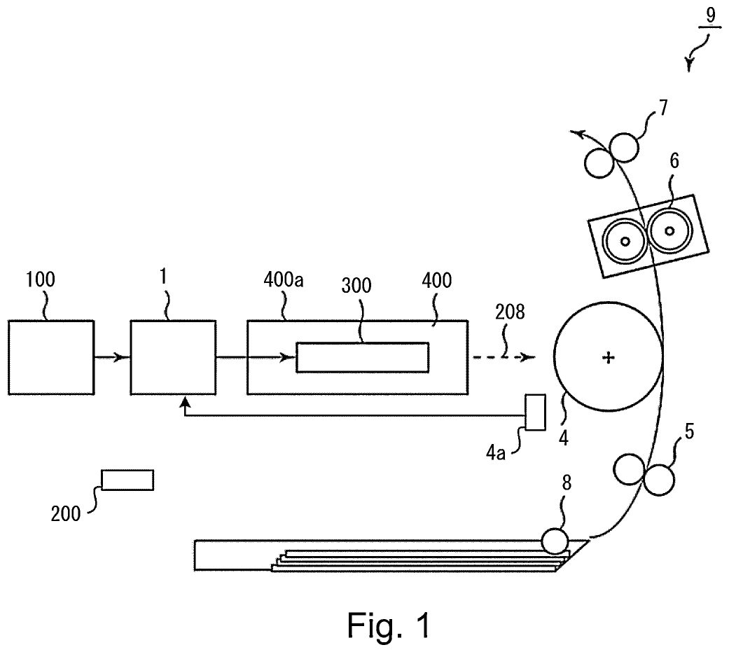

Hereinafter, an image forming apparatus in an Embodiment 1 will be described in detail with reference to the drawings. FIG. 1 is a schematic view illustrating a configuration of an image forming apparatus 9. A laser driving portion 300 in an optical scanning device 400, which is a light emitting means, emits a scanning light (laser light) 208 based on an image signal output from an image signal generating portion 100 and a control signal output from a control portion 1. A photosensitive drum (photosensitive member) 4, which is charged by an unshown charging means, is scanned by the laser light 208 to form a latent image on a surface of the photosensitive drum 4. Then, toner is adhered to the latent image by an unshown developing means to form a toner image corresponding to the latent image. The toner image is transferred to a recording medium, such as a paper, which is fed from a sheet feeding unit 8 and conveyed by a roller 5 to a position in contact with the photosensitive drum 4. The toner image transferred to the recording medium is thermally fixed to the recording medium in a fixing unit 6 and discharged outside an apparatus via a discharging roller 7.

Incidentally, a memory 4a is a memory for the photosensitive drum 4, and information on the photosensitive drum 4 is stored therein. The control portion 1 can read the information on the photosensitive drum 4 from the memory 4a. Here, the information on the photosensitive drum 4 includes information such as sensitivity information (high, low), usage information and usage environment. The usage information includes a usage history of the photosensitive drum 4, e.g., a lifetime of the photosensitive drum 4. The information of the usage environment includes temperature, humidity, etc. The image forming apparatus 9 is provided with an environment sensor 200, and the information of the usage environment such as the temperature and the humidity can be detected by the environment sensor 200.

### <Optical Scanning Device>

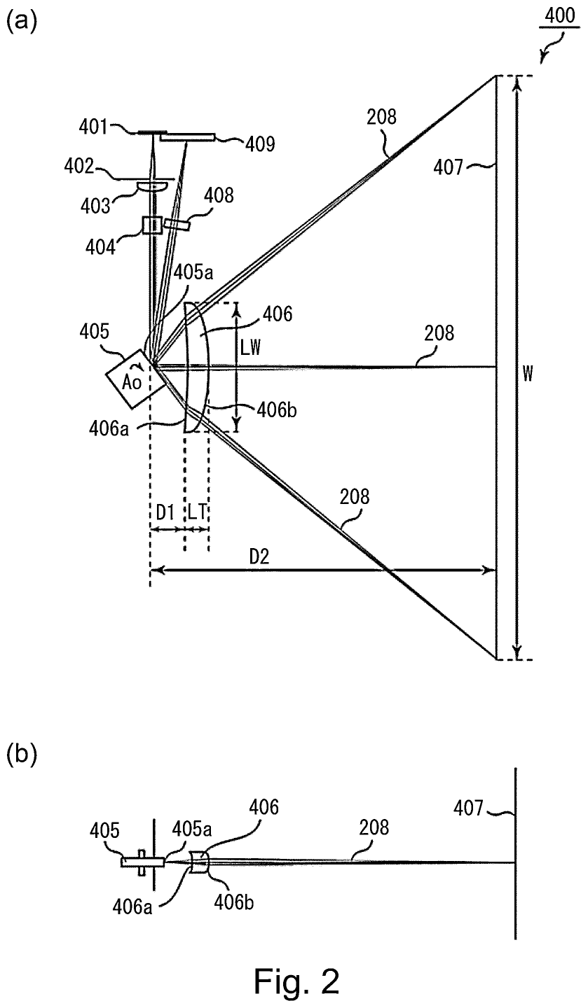

FIG. 2 are cross-sectional views of the optical scanning device 400 in the Embodiment 1, and part (a) of FIG. 2 illustrates a main scanning cross section and part (b) of FIG. 2 illustrates a sub scanning cross section. In the Embodiment 1, the laser light (light flux) 208 emitted from a light source 401 is shaped into an elliptical shape by an aperture diaphragm 402 and is incident on a coupling lens 403. The light flux which has passed through the coupling lens 403 is converted to an approximately collimated light and is incident on an anamorphic lens 404. Incidentally, the “approximately collimated light” includes weakly converged light and weakly diverged light. The anamorphic lens 404 includes a positive refractive power in the main scanning cross section and converts the incident light flux into the converged light in the main scanning cross section. In addition, the anamorphic lens 404 condenses the light flux in a vicinity of a deflecting surface 405a of a deflector 405 in the sub scanning cross section, forming a line image long in a main scanning direction.

The light flux which has passed through the anamorphic lens 404 is then reflected at the deflecting surface 405a of the deflector 405. The light flux reflected at the deflecting surface 405a passes through an imaging lens 406 as the laser light 208 (see FIG. 1) and is incident on the surface of the photosensitive drum 4. The imaging lens 406 is an imaging optical element. In the Embodiment 1, an imaging optical system is constituted by only a single imaging optical element (imaging lens 406). The surface of the photosensitive drum 4 on which the light flux which has passed through (transmitted through) the imaging lens 406 is incident is a scanned surface 407 which is scanned by the light flux. The imaging lens 406 causes the light flux to form an image on the scanned surface 407, and forms a predetermined spot-shaped image (spot). By rotating the deflector 405 at a constant angular speed in a direction of an arrow A by an unshown driving portion, the spot is moved in the main scanning direction on the scanned surface 407 to form an electrostatic latent image on the scanned surface 407. Incidentally, the main scanning direction is a direction parallel to the surface of the photosensitive drum 4 and perpendicular to a moving direction of the surface of the photosensitive drum 4. The sub scanning direction is a direction perpendicular to the main scanning direction and an optical axis of the light flux.

A beam detect (hereinafter referred to as BD) 409 and a BD lens 408 are an optical system for synchronization which determines a timing for writing the electrostatic latent image on the scanned surface 407. The light flux which has passed through the BD lens 408 is incident on and detected by the BD 409, which includes a photodiode. Control of the writing timing is performed based on the timing at which the light flux is detected by the BD 409.

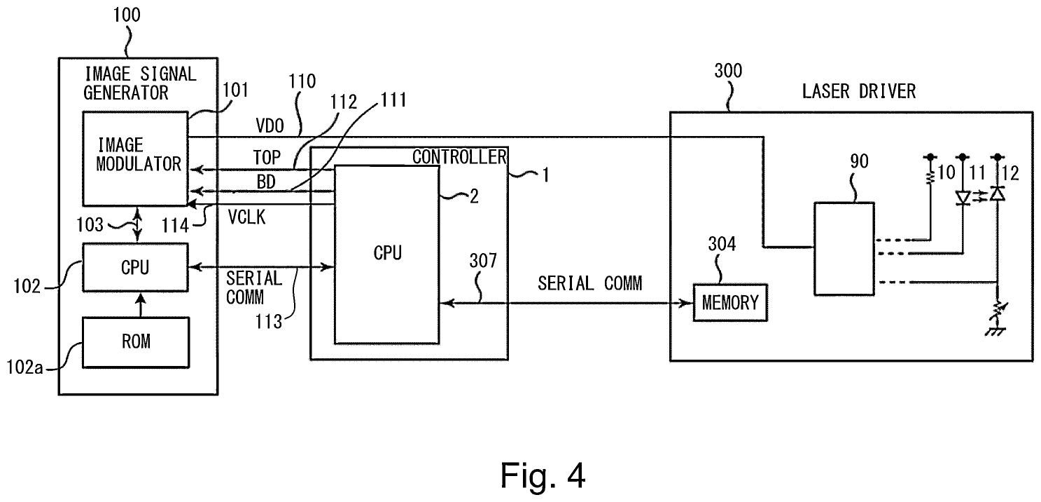

The light source 401 is a semiconductor laser chip. The light source 401 in the Embodiment 1 has a configuration in which one light emitting portion 11 is provided (see FIG. 4). However, as the light source 401, a plurality of the light emitting portions of which light emitting is independently controllable may be provided. Even in a case in which the plurality of the light emitting portions are provided, a plurality of the light fluxes emitted therefrom also reaches the scanned surface 407 via the coupling lens 403, the anamorphic lens 404, the deflector 405 and the imaging lens 406, respectively. On the scanned surface 407, the spots corresponding to each light flux are formed at positions shifted in the sub scanning direction, respectively.

Incidentally, the various types of the optical members such as the light source 401, the coupling lens 403, the anamorphic lens 404, the imaging lens 406 and the deflector 405 described above are accommodated in a housing 400a (optical box) (see FIG. 1).

### <Imaging Lens>

As shown in FIG. 2, the imaging lens 406 includes two optical surfaces (lens surfaces) of an incident surface 406a (first surface) and an emergent surface 406b (second surface). The imaging lens 406 is configured to cause the light flux deflected by the deflecting surface 405a to scan the scanned surface 407 with desired scanning characteristic in the main scanning cross section. In addition, the imaging lens 406 is configured to make the spot of the laser light 208 on the scanned surface 407 be a desired shape. In addition, due to the imaging lens 406, a vicinity of the deflecting surface 405a and a vicinity of the scanned surface 407 has conjugate relationship in the sub scanning cross section. By this, the configuration compensates for a face tangle error. Here, the compensation for the face tangle error is to reduce a scanning positional shift in the sub scanning direction on the scanned surface 407 when the deflecting surface 405a tilts.

Incidentally, the imaging lens 406 in the Embodiment 1 is a plastic molded lens formed by injection molding, however, a glass molded lens may be used as the imaging lens 406. Since the molded lens is easy to form aspherical shape and are suitable for mass production, productivity and optical performance thereof can be improved by employing the molded lens as the imaging lens 406.

The imaging lens 406 does not have the so-called an fθ characteristic. In other words, when the deflector 405 is rotated at the constant angular speed, the imaging lens 406 does not have a scanning characteristic which allows the spot of the light flux passing through the imaging lens 406 to move at the constant velocity on the scanned surface 407. Thus, by using the imaging lens 406 which does not have the fθ characteristic, it becomes possible to dispose the imaging lens 406 closer to the deflector 405, i.e., at a position in which a distance D1 is small. In addition, the imaging lens 406 which does not have the fθ characteristic can be made to be smaller with respect to the main scanning direction (a width LW) and an optical axis direction (a thickness LT) than the imaging lens which has the fθ characteristic. In lights of these, downsizing of the housing 400a of the optical scanning device 400 (see FIG. 1) is realized. In addition, in a case of the lens which has the fθ characteristic, there may be steep changes in shapes of the incident surface and the emergent surface of the lens as viewed in the main scanning cross section, and if there is such a restriction in shape, good imaging performance may not be obtained. In contrast, since the imaging lens 406 does not have the fθ characteristic, there is fewer steep changes in shapes of the incident surface and the emergent surface of the lens as viewed in the main scanning cross section, the good imaging performance can be obtained.

The scanning characteristic of the imaging lens 406 in the Embodiment 1 described above is expressed by the following equation (1).

$$\begin{matrix}[ Equation 1 ] & \\ Y = K / B tan ( B θ ) & ( 1 )\end{matrix}$$

In the equation (1), a scanning angle (scanning angle of view) by the deflector 405 is defined as θ, a condensed light position (image height) in the main scanning direction on the scanned surface 407 is defined as Y [mm], an imaging coefficient at an on-axis image height is defined as K [mm], a coefficient which determines the scanning characteristic of the imaging lens 406 (scanning characteristic coefficient) is defined as B. Incidentally, in the Embodiment 1, the on-axis image height refers to the image height on the optical axis (Y=0=Ymin), and corresponds to the scanning angle θ=0. In addition, an off-axis image height refers to the image height outside a central optical axis (when the scanning angle θ=0) (Y≠0), and corresponds to the scanning angles θ≠0. Furthermore, a most off-axis image height refers to the image height when the scanning angle θ is at a maximum thereof (maximum scanning angle of view) (Y=+Ymax,−Ymax).

Incidentally, a scanning width W, which is a width in the main scanning direction of a predetermined area (scanning area) in which the latent image can be formed on the scanned surface 407, is expressed as W=|+Ymax|+|−Ymax|. A center of the predetermined area is the on-axis image height, and an end portion is the most off-axis image height.

Here, the imaging coefficient K is a coefficient which corresponds to f in the scanning characteristic (fθ characteristic) Y=fθ in a case in which the collimated light is incident on the imaging lens 406. In other words, the imaging coefficient K is a coefficient to make the condensed light position Y and the scanning angle θ in proportional relationship as in the fθ characteristic in a case in which the light flux other than the collimated light is incident on the imaging lens 406.

To supplement the scanning characteristic coefficient, since the equation (1) when B=0 is Y=K θ, which corresponds to the scanning characteristic Y=f θ of the imaging lens used in a conventional optical scanning device. In addition, when B=1, the equation (1) is Y=K tan θ, which corresponds to a projecting characteristic Y=f tan θ of a lens used in an imaging device (camera), etc. In other words, by setting the scanning characteristic coefficient B in a range 0≤B≤1 in the equation (1), the scanning characteristic between the projecting characteristic Y=f tan θ and the fθ characteristic Y=f θ can be obtained.

Here, by differentiating the equation (1) by the scanning angle θ, a scanning speed of the light flux on the scanned surface 407 with respect to the scanning angle θ, as shown in an equation (2) below, can be obtained.

$$\begin{matrix}[ Equation 2 ] & \\ dY / d 0 = K / {cos}^{2} ( B θ ) & ( 2 )\end{matrix}$$

Furthermore, dividing the equation (2) by the speed dY/dθ=K at the on-axis image height yields the following equation (3).

$$\begin{matrix}[ Equation 3 ] & \\ ( dY / d θ ) / K - 1 = 1 / {cos}^{2} ( B θ ) - 1 = {tan}^{2} ( B θ ) & ( 3 )\end{matrix}$$

The equation (3) expresses a shifting amount (partial magnification) of the scanning speed of each off-axis image height relative to the scanning speed of the on-axis image height. In the optical scanning device 400 in the Embodiment 1, the scanning speeds of the light flux are different at the on-axis image height and at the off-axis image height except when B=0.

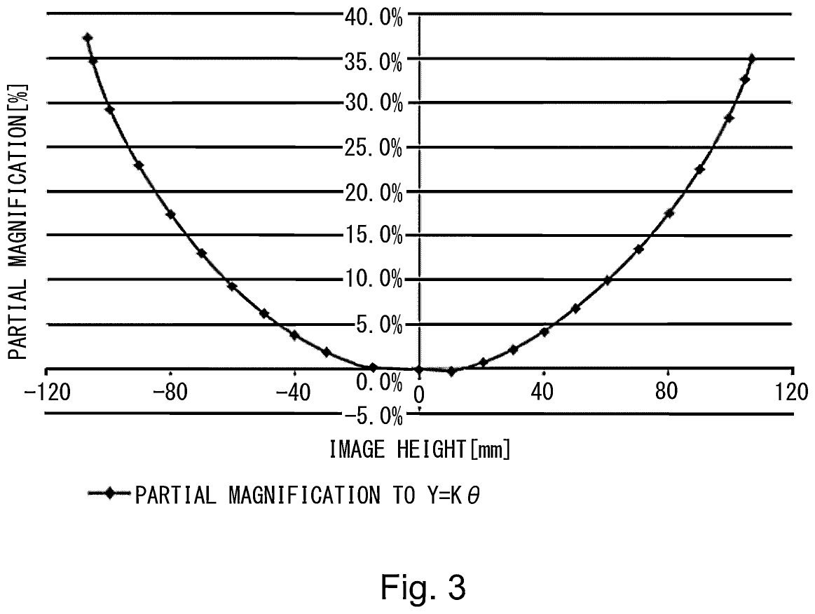

FIG. 3 illustrates relationship between the image height and the partial magnification when scanning positions on the scanned surface 407 in the Embodiment 1 are fitted with the characteristic of Y=K θ. In a graph in FIG. 3, a horizontal axis represents the image height [mm] and a vertical axis represents the partial magnification [%]. In addition, black dots represent the partial magnification corresponding to Y=K θ. In the Embodiment 1, by the scanning characteristic shown in the equation (1) being given to the imaging lens 406, as illustrated in FIG. 3, the scanning speed gradually becomes faster as it goes from the on-axis image height to the off-axis image height, and therefore the partial magnification gets larger. The partial magnification of 30% means that, when the light is irradiated for a unit time, an irradiating length in the main scanning direction on the scanned surface 407 becomes 1.3 times. Therefore, if the pixel width in the main scanning direction is determined at a constant time interval determined by a period of an image clock, pixel densities differ at the on-axis image height and at the off-axis image height.

In addition, as the image height Y goes away from the on-axis image height and approaches the most off-axis image height (as an absolute value of the image height Y gets larger), the scanning speed gradually increases. As a result, a time required to scan a unit length when the image height on the scanned surface 407 is near the most off-axis image height is shorter than a time required to scan the unit length when the image height is near the on-axis image height. This means that if luminous intensity of the light source 401 is constant, a total exposure amount per unit length when the image height is near the most off-axis image height is less than the total exposure amount per unit length when the image height is near the on-axis image height.

Thus, in a case of having the optical configuration as described above, variations in the partial magnification with respect to the main scanning direction and the total exposure amount per unit length may not be appropriate to maintain good image quality. Therefore, in the Embodiment 1, in order to obtain good image quality, correction for the partial magnification and luminance correction to correct the total exposure amount per unit length as described above are performed.

In particular, the shorter an optical passage length from the deflector 405 to the photosensitive drum 4, the greater the angle of view, and thus the greater the above difference in the scanning speeds at the on-axis image height and at the most off-axis image height. According to examination by the inventor, it becomes an optical configuration of which rate of change of the scanning speed is 20% or more, such as where the scanning speed at the most off-axis image height is 120% or more of the scanning speed at the on-axis image height. In a case of such an optical configuration, it may be difficult to maintain good image quality due to influence from the variations in the partial magnification with respect to the main scanning direction and the total exposure amount per unit length.

Incidentally, the rate of change C (%) of the scanning speed is a value expressed as C=((Vmax−Vmin)/Vmin)×100, where Vmin is the slowest scanning speed and Vmax is the fastest scanning speed. Incidentally, in the optical configuration in the Embodiment 1, the scanning speed is slowest at the on-axis image height (center portion of the scanning area) and fastest at the most off-axis image height (end portion of the scanning area).

Incidentally, according to examination by the inventor, it is found that, in a case of the optical configuration having the angle of view of 52° or more, the rate of change of the scanning speed becomes 30% or more. Conditions under which the angle of view becomes 52° or more are as following. For example, in a case of the optical configuration which forms the latent image having the width of a short side of an A4 sheet with respect to the main scanning direction, the scanning width W=214 mm and an optical passage length D2 (see FIG. 2)=125 mm or less from the deflecting surface 405a to the scanned surface 407 when the scanning angle of view is 0°. In a case of the optical configuration which forms the latent image having the width of the short side of an A3 sheet with respect to the main scanning direction, the scanning width W=300 mm and the optical passage length D2 (see FIG. 2)=247 mm or less from the deflecting surface 405a to the scanned surface 407 when the scanning angle is 0°. In the image forming apparatus having such optical configurations, by employing the configuration in the Embodiment 1 described below, it becomes possible to obtain good image quality even when using the imaging lens which does not have the fθ characteristic.

### <Configuration for an Exposure Control>

FIG. 4 is an electrical block diagram illustrating a configuration for an exposure control in the image forming apparatus 9. The image signal generating portion 100 includes an image modulating portion 101, a CPU 102 and a ROM 102a. The image signal generating portion 100 receives printing information from an unshown host computer and generates a VDO signal 110 corresponding to image data (image signal). In addition, the image signal generating portion 100 has a function as a pixel width correcting means and a function as a density correcting means which corrects image density. The control portion 1 performs control of the image forming apparatus 9. The laser driving portion 300 is provided with a memory 304, a laser driver IC 90 and the light emitting portion 11 of the light source 401. The laser driver IC 90 controls ON/OFF of light emitting of the light source 401 based on the VDO signal 110 by switching whether current IL is applied to the light emitting portion 11 to emit light or to a dummy resistor 10 to turn off the light emitting portion 11. A photodetector 12 detects a light quantity of the light emitting portion 11. A CPU core 2 reads out information from the memory 304 by performing a serial communication 307 with the memory 304.

When the image signal generating portion 100 is ready to output the image signal for an image formation, the image signal generating portion 100 instructs the control portion 1 to start printing through a serial communication 113. The control portion 1 includes the CPU core 2, and when it is ready to print, then the control portion 1 sends a TOP signal 112, which is a sub scanning synchronizing signal, and a BD signal 111, which is a main scanning synchronizing signal, to the image signal generating portion 100. The image signal generating portion 100 outputs the VDO signal 110, which is the image signal, to the laser driving portion 300 at a predetermined timing after receiving the synchronizing signal.

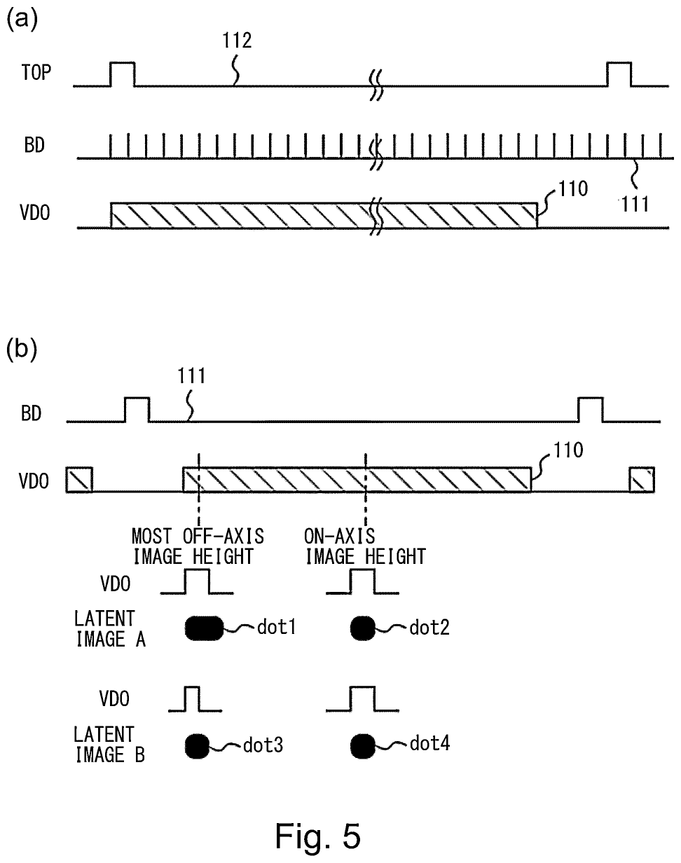

Part (a) of FIG. 5 is a timing chart of various types of the synchronizing signal and the image signal when an image forming operation equivalent to one page of the recording medium is performed. Time lapses from left to right in the figure. A “HIGH” of the TOP signal 112 indicates that a tip of the recording medium reaches a predetermined position. Upon receiving the “HIGH” of the TOP signal 112, the image signal generating portion 100 sends the VDO signal 110 in synchronization with the BD signal 111. Based on this VDO signal 110, the light source 401 emits light to form the latent image on the photosensitive drum 4.

Incidentally, in part (a) of FIG. 5, for simplification of the figure, the VDO signal 110 is described as being output continuously over a plurality of the BD signals 111. In practice, however, the VDO signal 110 is output during a predetermined period within a period between the BD signal 111 is output and the next BD signal 111 is output.

### <Partial Magnification Correcting Method>

### (Pixel Piece Insertion and Removal Method)

Next, a partial magnification correcting method will be described. Prior to description thereof, factors of the partial magnification and principle of the correction will be described using part (b) of FIG. 5. Part (b) of FIG. 5 is a view illustrating timings of the BD signal 111 and the VDO signal 110, and dot images formed by the latent image on the scanned surface 407. Time lapses from left to right in the figure.

Upon receiving a leading edge of the BD signal 111, the image signal generating portion 100 sends the VDO signal 110 after a predetermined timing so that the latent image is formed at a position which is away from a left end of the photosensitive drum 4 by a predetermined distance. And based on the VDO signal 110, the light source 401 emits light to form the latent image corresponding to the VDO signal 110 on the scanned surface 407.

Here, a case in which dot-shaped latent images are formed by causing the light source 401 to emit light for the same period at the on-axis image height and at the most off-axis image height based on the VDO signal 110 will be described. A size of the dot is equivalent to one dot of 600 dpi (width of 42.3 μm in the main scanning direction). The optical scanning device 400, as described above, has the optical configuration in which the scanning speed at the end portion (the most off-axis image height) is faster than that at the center portion (on-axis image height) on the scanned surface 407. As shown in a latent image A, a latent image dot1 at the most off-axis image height is enlarged (extended) in the main scanning direction relative to a latent image dot2 at the on-axis image height. Therefore, in the Embodiment 1, as the partial magnification correction, a period and a time width of the VDO signal 110 is corrected depending on a position in the main scanning direction. That is, through the partial magnification correction, duration of a light emitting time at the most off-axis image height is shortened relative to the duration of the light emitting time at the on-axis image height to make sizes of a latent image dot3 at the most off-axis image height and a latent image dot4 at the on-axis image height equal, as shown in a latent image B. Through such a correction, with respect to the main scanning direction, it becomes possible to form the dot-shaped latent image corresponding to each pixel having substantially equal width.

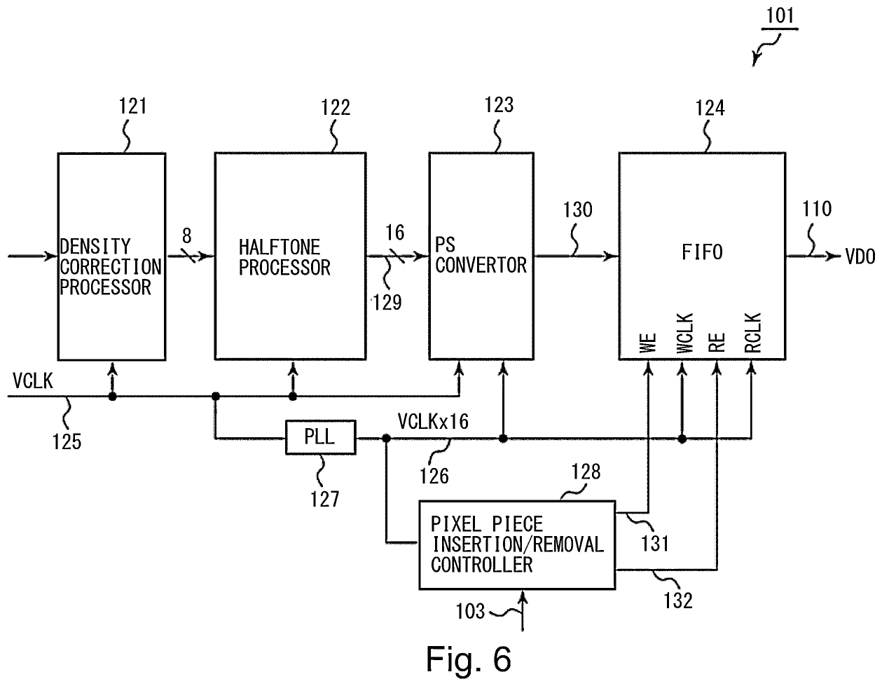

Next, using FIG. 6 through FIG. 10, specific processes of the partial magnification correction, in which an irradiating time of the light source 401 is shortened only by an increased amount of the partial magnification as it is moved from the on-axis image height to the off-axis image height, will be described. FIG. 6 is a block diagram illustrating an example of the image modulating portion 101. A halftone processing portion 122 performs a converting process in which screening (dithering) process is applied to the image signal of multi-value parallel 8-bit input from a density correction processing portion 121 to express the image signal in density with the image forming apparatus 9.

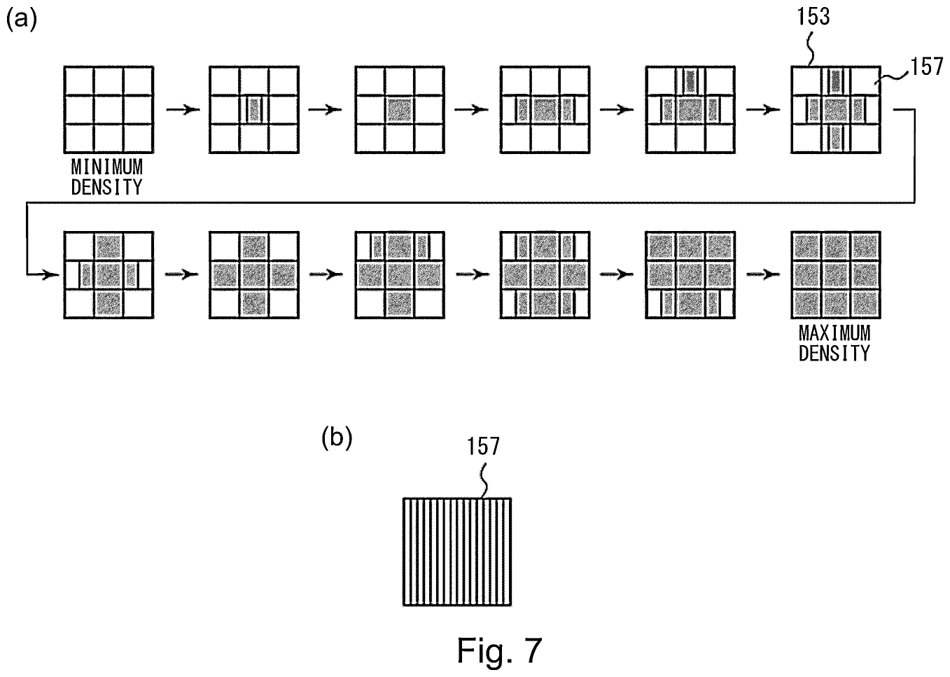

Part (a) of FIG. 7 is an example of a screen, and what performs density expression with 200 lines (lpi) of matrix 153 each having three main scanning pixels and three sub scanning pixels. White portions in the figure are portions where the light source 401 is not caused to emit light (off), and black portions are portions in which the light source 401 is caused to emit light (on). The matrix 153 is provided for each gray scale, and the gray scale is up in order indicated by arrows (density becomes denser). In the Embodiment 1, one pixel 157 is a unit which separates the image data to form the one dot of 600 dpi on the scanned surface 407.

As shown in part (b) of FIG. 7, in a state before the pixel width is corrected, one pixel is constituted by sixteen pixel pieces having a width of one sixteenth ( 1/16) of a width of one pixel, and the light source 401 can be switched on and off for each pixel piece. In other words, in one pixel, sixteen steps of the gray scale can be expressed. A PS converting portion 123 is a parallel-serial converting portion and converts a parallel 16-bit signal 129 input from the halftone processing portion 122 to a serial signal 130. An FIFO 124 receives the serial signal 130, stores the serial signal 130 in an unshown line buffer, and, after a predetermined time, also as the serial signal, outputs to the laser driving portion 300 of a later stage as the VDO signal 110. Control of writing and reading of the FIFO 124 is performed by a pixel piece insertion and removal control portion 128 controlling a write enable (WE) signal 131 and a read enable (RE) signal 132 based on characteristic information on the partial magnification received from the CPU 102 via a CPU bus 103. PLL portion 127 supplies a clock (VCLK×16) 126, which is multiplied by sixteen times a frequency of a clock (VCLK) 125 corresponding to one pixel, to the PS converting portion 123 and to the FIFO 124.

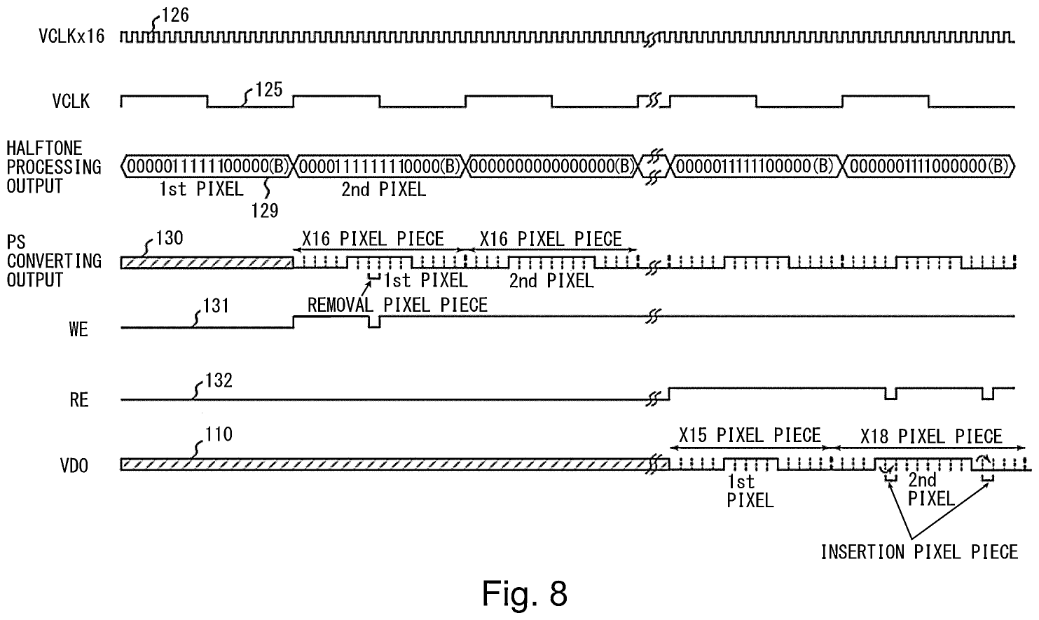

Next, operations after a forced OFF process of the block diagram in FIG. 6 will be described using a time chart on operations of the image modulating portion 101 in FIG. 8. As described above, the PS converting portion 123 receives the multi-value 16-bit signal 129 from the halftone processing portion 122 (forced OFF processing portion) in synchronization with the clock 125, and sends the serial signal 130 to the FIFO 124 in synchronization with the clock 126.

The FIFO 124 receives the signal 130 only when the WE signal 131 is valid “HIGH”. In a case in which the image is shortened in the main scanning direction to correct the partial magnification, the pixel piece insertion and removal control portion 128 controls so that the FIFO 124 does not receive the serial signal 130 by partially setting the WE signal to invalid “LOW”. In other words, the pixel piece insertion and removal control portion 128 removes the pixel piece. In FIG. 8, in a configuration in which one pixel is constituted by sixteen pixel pieces in a usual case, an example in which one pixel piece is removed from a first pixel and the first pixel becomes constituted by fifteen pixel pieces is illustrated.

In addition, the FIFO 124 reads data stored only when the RE signal 132 is valid “HIGH” in synchronization with the clock 126 (VCLK×16), and outputs the VDO signal 110. In a case in which the image is lengthened in the main scanning direction to correct the partial magnification, the pixel piece insertion and removal control portion 128 causes the FIFO 124 not to update the read data and continue to output data of one clock before of the clock 126 by partially setting the RE signal 132 to invalid “LOW”. In other words, the pixel piece insertion and removal control portion 128 inserts the pixel piece of the same data as that of the pixel piece, which is next thereto on an upstream side with respect to the main scanning direction and is processed immediately before. In FIG. 8, in the configuration in which one pixel is constituted by sixteen pixel pieces in a usual case, an example in which two pixel pieces are inserted in a second pixel and the second pixel becomes constituted by eighteen pixel pieces is illustrated. Incidentally, the FIFO 124 used in the Embodiment 1 is described as a circuit having a configuration in which, when the RE signal is set to the invalid “LOW”, the output does not become a Hi-Z state but continues the previous output.

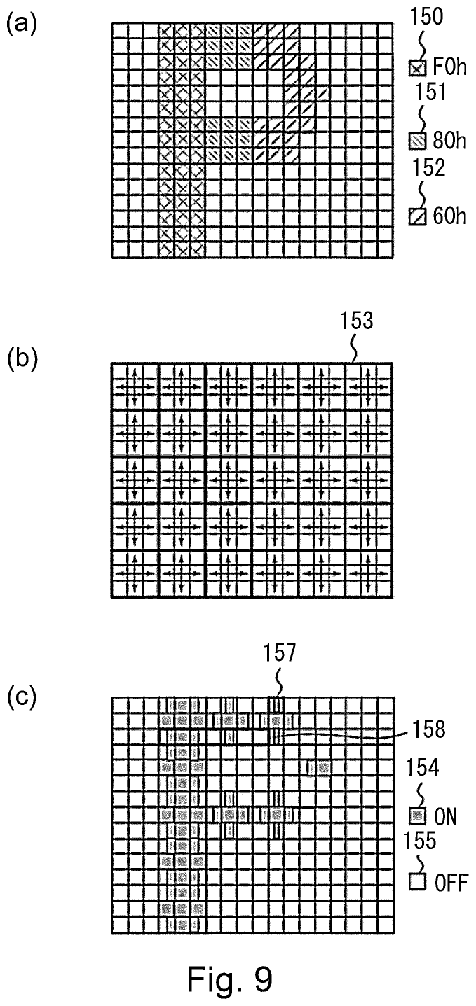

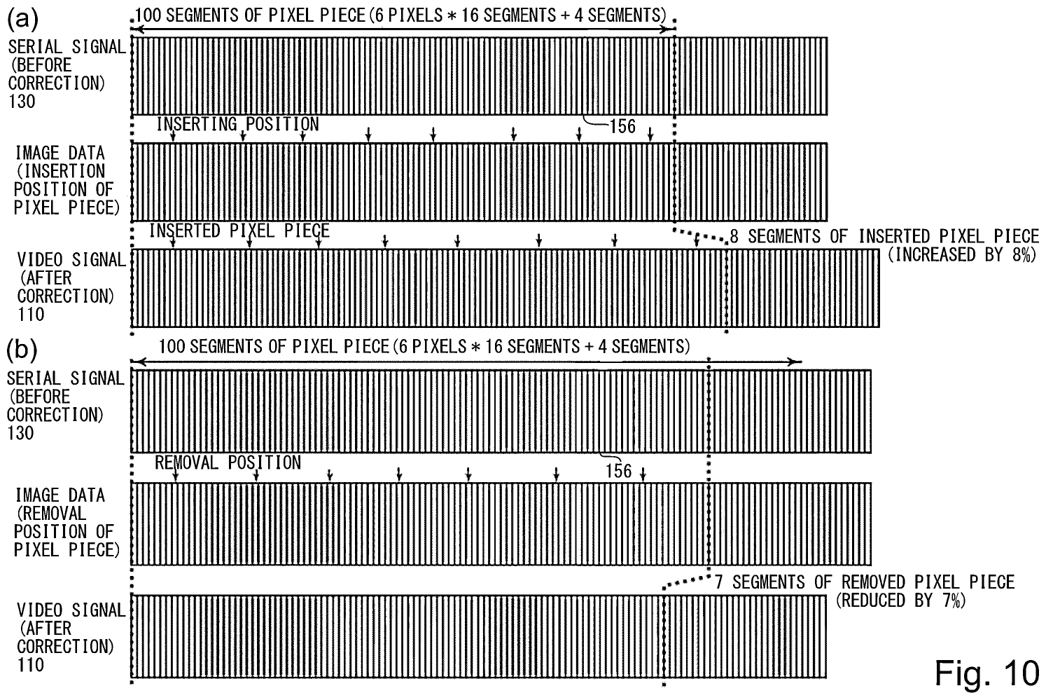

FIG. 9 and FIG. 10 are views illustrating from the parallel 16-bit signal 129, which is the input image of the halftone processing portion 122, to the VDO signal 110, which is the output of the FIFO 124, using an image example. Part (a) of FIG. 9 illustrates an example of the image signal of the multi-value parallel 8-bit input to the halftone processing portion 122. Each pixel has 8-bit density information. A pixel 150 represents F0h, a pixel 151 represents 80h, a pixel 152 represents 60h, and a white portion represents 00h of the density information. Part (b) of FIG. 9 is the screen, which grows from a center with 200 lines, as described in FIG. 7. Part (c) of FIG. 9 is the image example of the image signal, which is the parallel 16-bit signal 129 after the halftone process, and as described above, each pixel 157 is constituted by sixteen pixel pieces. A pixel piece 154 represents the pixel piece where it is ON and a pixel piece 155 represents the pixel piece where it is OFF.

FIG. 10 illustrates an example in which the image is extended by inserting the pixel pieces and an example in which the image is shortened by removing the pixel pieces with respect to the serial signal 130, focusing on an area 158 having seven pixels in the main scanning direction in part (c) of FIG. 9. A pixel piece 156 represents one pixel piece. Part (a) of FIG. 10 illustrates an example in which the partial magnification is increased by 8%. To a group of one hundred continuous pixel pieces, by inserting a total of eight pixel pieces with the same interval or approximately the same interval, the latent image can be extended in the main scanning direction by changing the pixel width so as to increase the partial magnification by 8%. Part (b) of FIG. 10 illustrates an example in which the partial magnification is reduced by 7%. To the group of one hundred continuous pixel pieces, by removing a total of seven pixel pieces with the same interval or approximately the same interval, the latent image can be shortened in the main scanning direction by changing the pixel width so as to reduce the partial magnification by 7%.

As such, through the partial magnification correction, by changing the pixel width of which a length in the main scanning direction is less than one pixel, the dot-shaped latent images corresponding to each pixel in the image data can be formed with substantially the same width with respect to the main scanning direction. Incidentally, the term substantially the same width with respect to the main scanning direction includes those in which each pixel is not disposed with completely the same width. In other words, there may be some variation in pixel widths as a result of the partial magnification correction, and the pixel widths may be the same width on average within a predetermined image height range. As described above, in the cases in which the pixel pieces are inserted or removed with the same interval or approximately the same interval, when numbers of the pixel pieces constituting the pixels are compared between two neighboring pixels, difference in the numbers of the pixel pieces constituting the pixels is 0 or 1. Therefore, the variation in the image density in the main scanning direction can be suppressed compared to the original image data, the good image quality can be obtained. In addition, positions at which the pixel pieces are inserted or removed may be, with respect to the main scanning direction, the same position for each scanning line (line) or the positions may be shifted.

As described above, as the absolute value of the image height Y increases, the scanning speed increases. Therefore, in the partial magnification correction, the described-above insertion and/or removal of the pixel pieces are performed so that the image becomes shorter (the length of one pixel becomes shorter) as the absolute value of the image height Y increases. In this manner, it becomes possible to form the latent image corresponding to each pixel with substantially the same width with respect to the main scanning direction, and correct the partial magnification appropriately.

### (Clock Frequency Correcting Method)

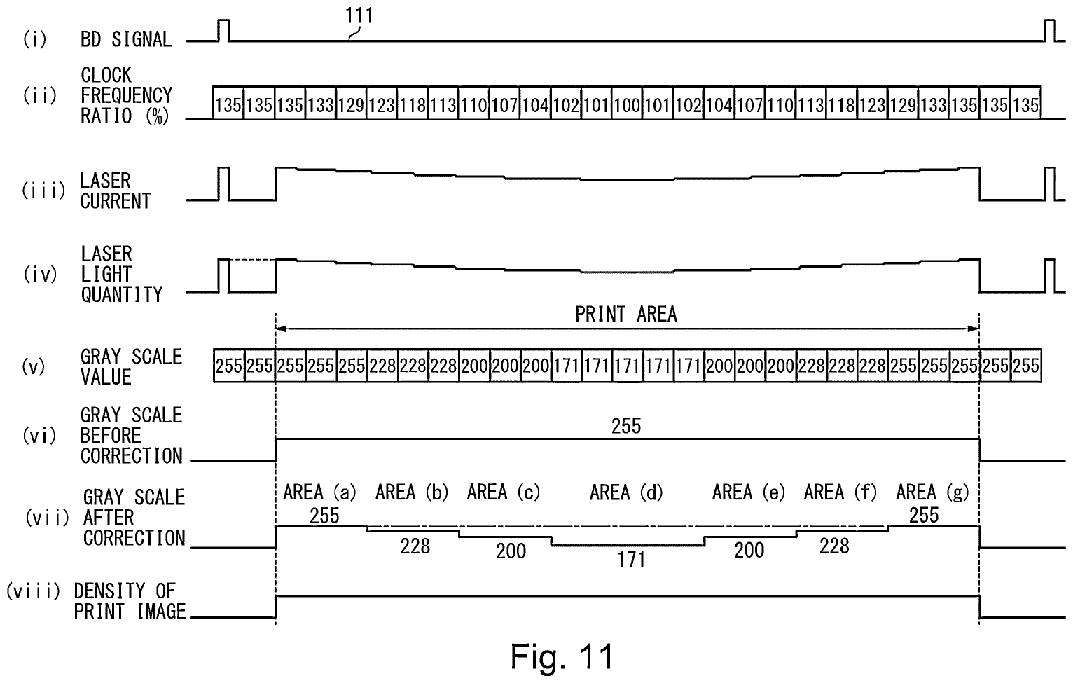

Specific methods for correcting the partial magnification are not limited to the pixel piece insertion and removal method described above. Here, a method for adjusting a clock frequency depending on the image height so that the pixel widths are approximately the same regardless of the image height. FIG. 11 is a view illustrating an example of the correction for the partial magnification described in FIG. 3. (i) shows the BD signal 111 output from the BD 409, and (ii) shows ratio of the clock frequency (clock frequency ratio) (%). For example, the clock frequency ratio is 100% at the on-axis image height and 135% at the most off-axis image height. (iii) shows the current applied to the light source 401, and (iv) shows the light quantity emitted from the light source 401. (v) shows the corrected gray scale values. For example, the corrected gray scale values are 171 at the on-axis image height and 255 at the most off-axis image height. (vi) shows the gray scale values of the print data before the density correction. In this example, the gray scale values are 255 over the entire image height. (vii) shows the gray scale values of the print data after the density correction, in which the print area is divided into seven areas ((a) to (g)) in the main scanning direction, and for example, the gray scale values are 171 in the area (d), which includes the on-axis image height, and 255 in the area (a) and (g), which include the most off-axis image height. (viii) shows the density of the print image, which is constant density in the main scanning direction due to the clock frequency correction.

In FIG. 11, a case, in which the change of the scanning speed is 35%, and the partial magnification correction of 135% occurs at the most off-axis image height when the scanning speed at the on-axis image height is defined as 100%, is described as an example. In the ROM 102a in FIG. 4, the clock frequency ratio for the optical scanning device 400 is stored, and the CPU core 2, based on this information, sends a video clock signal (VCLK) 114 to the image modulating portion 101 to control the clock frequency. In other words, the clock frequency ratio of the VDO signal 110 sent from the image modulating portion 101 is set to 135% at the most off-axis image height when that at the on-axis image height is defined as 100%. At this time, period during which the spot of the laser light 208 is moved over the scanned surface 407 by the width of one pixel (e.g., 42.3 μm) at the most off-axis image height is 0.74 times of that at the on-axis image height. As such, by the pixel width being corrected by controlling the exposure time of the laser light 208 at the pixel position corresponding to one pixel, it becomes possible to form the latent image corresponding to each pixel with substantially the same width and the same size with respect to the main scanning direction.

### <Image Width Correcting Process>

Next, an image width correcting process, in which difference in widths of the toner images (image widths) formed at the center portion of the print area and at the end portion of the print area in the Embodiment 1 is corrected by an image processing, will be described. Even if the scanning lens having the fθ characteristic is not used and the width of each pixel is made the same by the partial magnification correction, for example, the speeds of the spot of the laser light being moved on the surface of the photosensitive drum 4 to form one pixel is different between one pixel at the end portion and one pixel at the center portion in the main scanning direction. Therefore, the exposure amounts per unit area are different between the pixel at the end portion and the pixel at the center portion with respect to the main scanning direction. Examples of problems which occur due to the difference in the exposure amounts at the center portion and at the end portion include difference in the widths of the toner images (image widths) formed on the photosensitive drum 4.

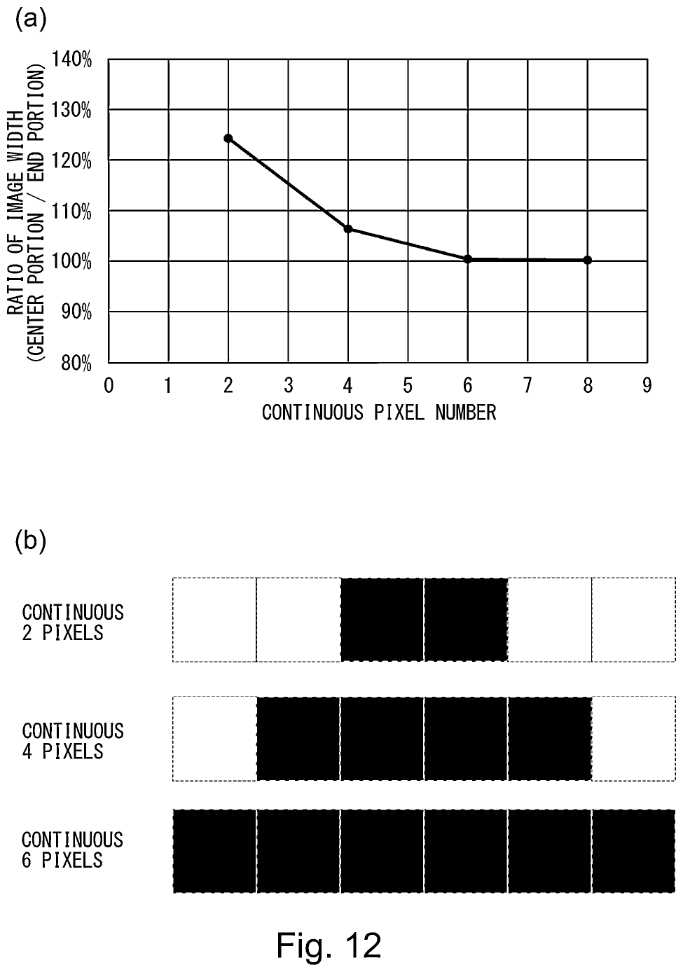

FIG. 12 is a view for describing the difference in the image widths of the toner image formed at the center portion in the print area and of the toner image formed at the end portion in the print area. In part (a) of FIG. 12, a horizontal axis represents a continuous pixel number upon forming the toner image, and a vertical axis represents ratio of the image widths at the center portion and at the end portion (center portion=end portion). The continuous pixel number is a number of pixels which are continuously exposed in the main scanning direction, and as examples, in part (b) of FIG. 12, the image data of cases of two continuous pixels, four continuous pixels and six continuous pixels are shown.

As shown in part (a) of FIG. 12, in the case in which the continuous pixel number is two or four, the image width at the center portion is thicker than the image width at the end portion. On the other hand, in the case in which the continuous pixel number is six or eight, the image widths are not that different at the center portion and at the end portion. In other words, depending on the continuous pixel number, relationship of the image width at the center portion and the image width at the end portion changes, and this difference gets larger when the continuous pixel number gets smaller. Here, a reason why the larger difference occurs in the image widths of the center portion and of the end portion when the continuous pixel number is small will be described.

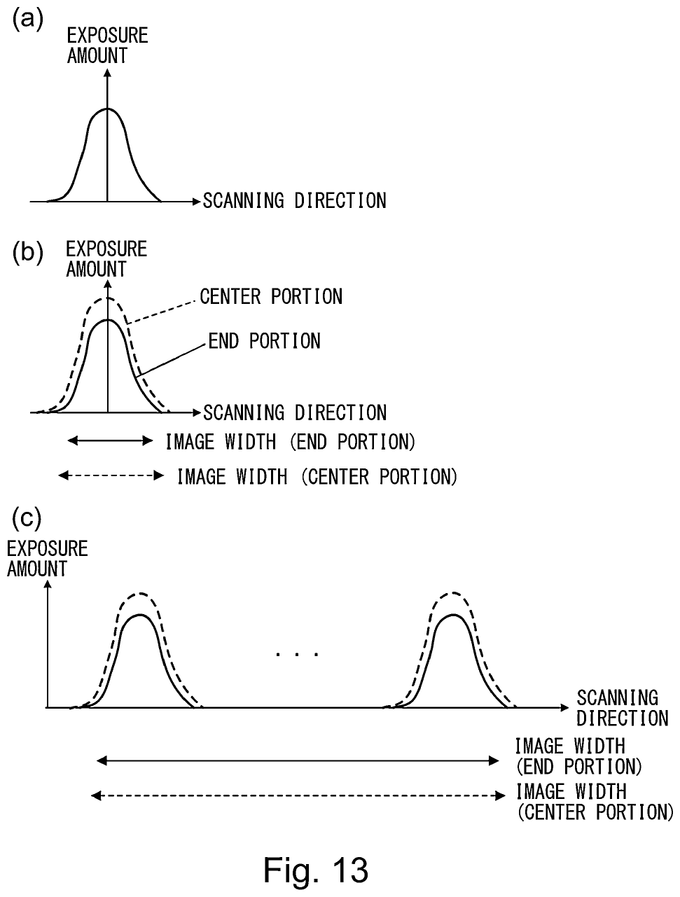

FIG. 13 is a view for describing effect of the exposure amount of the laser on the formation of the electrostatic latent image.

A horizontal axis in part (a) of FIG. 13 represents positions in the scanning direction and a vertical axis in part (a) of FIG. 13 represents a dimension of the exposure amount, and an example of a light quantity distribution of the laser in a case in which the light emission is performed to one pixel is shown. As shown in part (a) of FIG. 13, the light quantity distribution of the laser is not constant with respect to the scanning direction, but generally shows a Gaussian distribution.

Part (b) of FIG. 13 is a view illustrating difference in the light quantity distributions of the laser at the center portion and at the end portion in the case in which the light emission is performed to one pixel. As described above, the exposure amount of the laser is different at the center portion and at the end portion, the center portion, shown by a broken line, has a larger exposure amount than the end portion, shown by a solid line, and the light quantity distributions also differ. By this light quantity distribution, the width of the latent image formed on the photosensitive drum 4 is determined, and then the width of the toner image to be developed, that is, the image width is also determined. As shown at a lower portion of part (b) of FIG. 13, in the case in which the light emission is performed to one pixel, the image width at the center portion is thicker than the image width at the end portion.

Part (c) of FIG. 13 is a view illustrating the differences in the image widths at the center portion and at the end portion in a case in which the exposure is performed continuously to a plurality of pixels. Due to the difference in the light quantity distributions at the center portion and at the end portion, the image width at the center portion is thicker than that at the end portion. However, compared to the case in which the light emission is performed to only one pixel, in the case in which the exposure is performed continuously to the plurality of the pixels, since the image width itself is thicker, ratio of change in the image widths at the center portion and at the end portion due to the difference in light quantity distribution becomes minor. As a result, as shown in part (a) of FIG. 12, in a case in which the continuous pixel number is small, the image width at the center portion becomes thicker, and in a case in which the continuous pixel number is large, the difference in the image widths at the center portion and at the end portion becomes smaller.

Here, a method through which the image widths at the center portion and at the end portion are regulated by performing an image processing will be described. As mentioned above, the image width is determined by the width of the electrostatic latent image formed on the photosensitive drum 4. Therefore, by thinning an exposure width on the photosensitive drum 4, the width of the electrostatic latent image can be thinned and the image width can be thinned.

Examples of means to thin the image width of the continuous pixels include to thin the exposure widths of outermost pixels, whose pixel positions are at both ends, of the continuous pixels. By thinning the exposure widths of the outermost pixels, it becomes possible to thin the width of the electrostatic latent image of the entire continuous pixels. In the Embodiment 1, as shown in part (b) of FIG. 7, one pixel is constituted by the pixel pieces which is made by one dot of 600 dpi being divided into sixteen pieces, and by the light source being turned off in units of one pixel piece according to a processing value read from the memory 304, it becomes possible to thin the width of the electrostatic latent image. In addition, as for an inside pixel of the continuous pixels, even if the exposure width thereof is changed, the width of the electrostatic latent image of the entire continuous pixels is hardly affected.

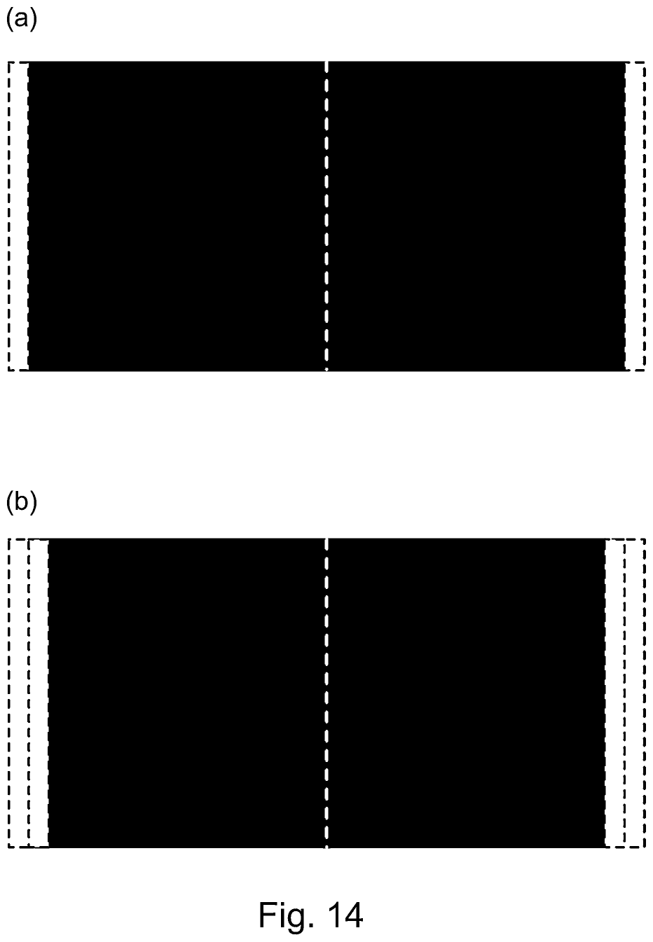

FIG. 14 is a view describing that, in the case in which the continuous pixel number is two, by turning off the light source for each pixel piece, the pixel widths of the outermost pixels are shortened. Part (a) of FIG. 14 illustrates an example in which, by setting a removing number of the pixel pieces per pixel to one, the pixel width is shortened. Part (b) of FIG. 14 illustrates an example in which, by setting the removing number of the pixel pieces per pixel to two, the pixel width is shortened.

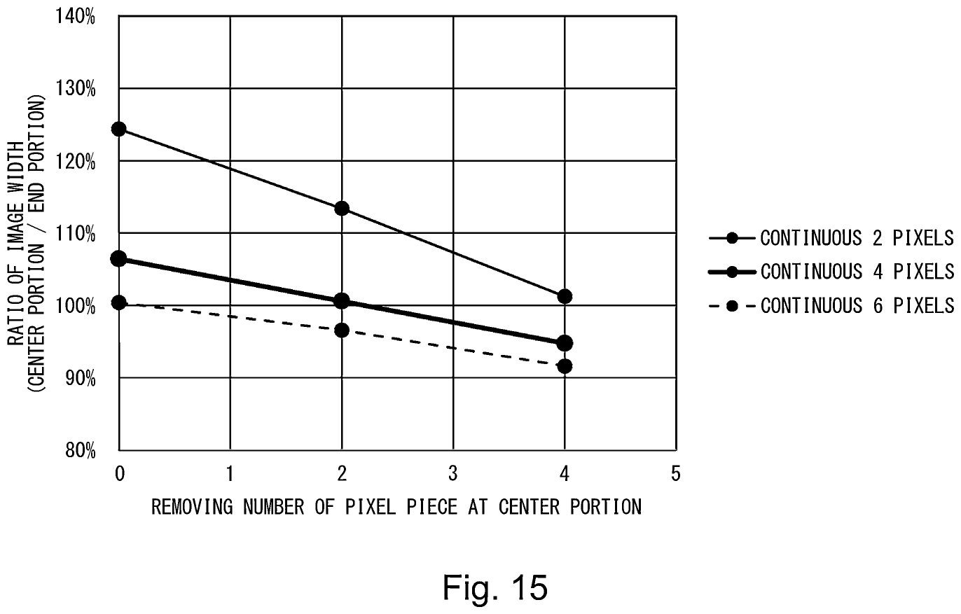

Using FIG. 15, effect of the correcting process of the image width in the Embodiment 1 on the image width will be described. A horizontal axis in FIG. 15 represents the removing number of the pixel pieces per pixel at the center portion. A vertical axis in FIG. 15 represents the ratio of the image widths at the center portion and at the end portion (center portion:end portion). In FIG. 15, differences of the image widths in three cases are shown: a solid thin line shows results of a case in which the continuous pixels are two, a solid thick line shows results of a case in which the continuous pixels are four, and a broken line shows results of a case in which the continuous pixels are six, respectively.

In the cases in which the continuous pixels are two or four, the image width at the center portion is thicker, as described above, when the removing number is zero. As the removing number at the center portion is increased, the image width at the center portion gets thinner, and the removing number, which brings the width of the toner image at the center portion and at the end portion closer, is four when the continuous pixels are two, and two when the continuous pixels are four. On the other hand, in the case in which the continuous pixels are six, the width of the toner images at the center portion and at the end portion are close to each other when the removing number is zero. In addition, in the case in which the continuous pixels are six, as the removing number is increased, the width of the toner image at the center portion gets thinner compared to that at the end portion.

In Table 1, the optimal removing numbers which bring the image widths at the center portion and at the end portion closer are shown. In Table 1, the continuous pixel numbers are shown in a first row, and the optimal numbers of the removing pixel pieces for the corresponding continuous pixel numbers are shown in a second row. The optimal removing number varies depending on the continuous pixel number, and the less the continuous pixels, the more the optimal removing number.

TABLE 1

| Continuous pixel number | 2 | 3 | 4 | 5 | 6 or more |
|---|---|---|---|---|---|
| Optimal number of | 4 | 3 | 2 | 1 | 0 |
| the removing pixel pieces | | | | | |

Based on this result, in the Embodiment 1, depending on the continuous pixel number for forming the toner image, by changing the number of the removing pixel pieces at the outermost pixels, the image widths at the center portion and at the end portion are regulated. The control portion 1 functions as a determining means which determines the number of removing pixel pieces at the outermost pixels depending on the continuous pixel number.

Incidentally, the relationship between the continuous pixel number and the optimal number of the removing pixel pieces (FIG. 15, Table 1) varies depending on the difference in the exposure amounts at the center portion and at the end portion. For example, if the exposure amount at the center portion is even greater than the exposure amount at the end portion, since the image width at the center portion gets even thicker than that at the end portion, the optimal number of the removing pixel pieces gets more.

### <Control Related to Settings for the Image Width Correcting Process>

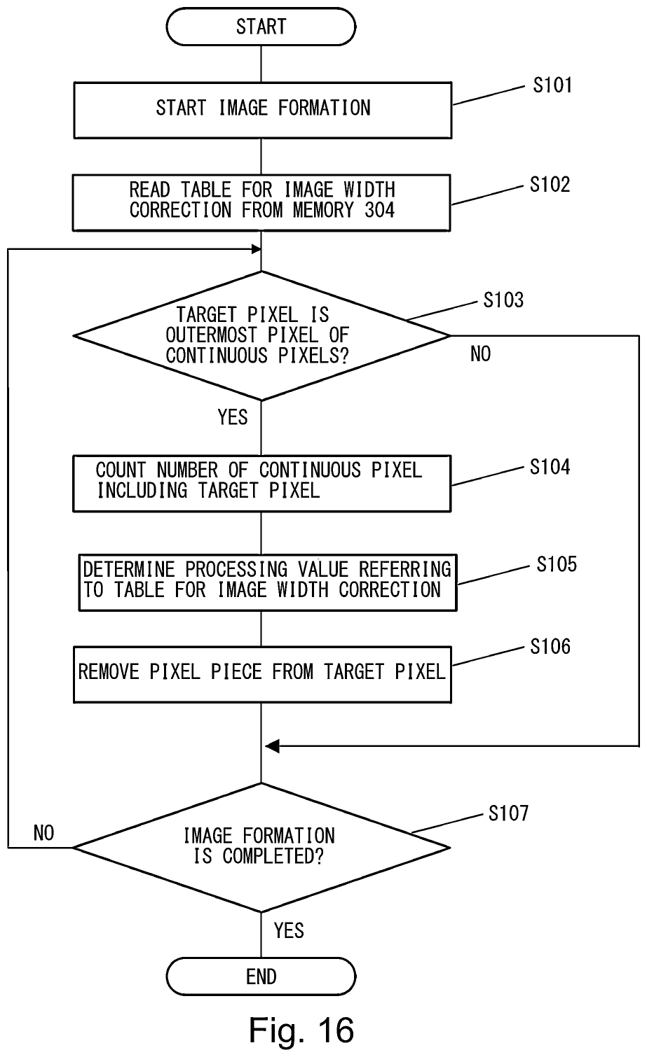

In the Embodiment 1, in light of the relationship between the number of the removing pixel pieces for the image width correcting process and the image width described above, a removing method of the pixel piece for the image width correcting process is changed based on the continuous pixel number. FIG. 16 is a flowchart illustrating the method of the image width correcting process in the Embodiment 1. The control portion 1 functions as a correcting means which performs the image width correcting process.

In Step (hereinafter referred to as S) 101, the control portion 1 receives information of the print job and initiates the image formation. In S102, the control portion 1 reads the processing value for the image width correction (the number of the removing pixel pieces) from the memory 304 in the Embodiment 1. The read processing value is stored in the image modulating portion 101. In the Embodiment 1, the processing value for the image width correction are stored in the memory 304 in the table format shown in Table 1.

In S103, the control portion 1 determines whether or not the pixel which is a target on which the exposure will be performed (hereinafter referred to as a “target pixel”) is the outermost pixel of the continuous pixels. If the control portion 1 determines in S103 that the target pixel is not the outermost pixel of the continuous pixels, then proceeds the process to S107. If the control portion 1 determines in S103 that the target pixel is the outermost pixel of the continuous pixels, then proceeds the process to S104.

In S104, the control portion 1 counts the number of continuous pixel including the target pixel (continuous number). In S105, the control portion 1 refers to the table for the image width correction (e.g., Table 1) to determine the processing value. For example, in a case in which the target pixel is the outermost pixel of the continuous pixels and the continuous number is four, the control portion 1 determines the processing value, i.e., the optimal number of the removing pixel pieces to be “two” from Table 1.

In S106, the control portion 1 performs the removing of the pixel piece from the target pixel based on the processing value (optimal number of the removing pixel pieces) determined in S105. Incidentally, performing the removing of the pixel piece from the target pixel means, in more detail, dividing pixel data of one pixel into a predetermined number of the pixel pieces (e.g., sixteen), performing the removing process, and then generating an image signal corresponding to the pixel data of one pixel after the removing of the pixel pieces. In other words, after correcting the image data of one pixel to an optimal number of the pixel pieces, the image signal for one pixel corresponding to the corrected number of the pixel pieces is generated. In S107, the control portion 1 determines whether or not the image formation is completed. If the control portion 1 determines in S107 that the image formation is not completed, then returns the process to S103, and if the control portion 1 determines that the image formation is completed, then terminates the image formation.

### Effect

Next, effects of the Embodiment 1 will be further described based on a specific example of the image width correcting method. Here, using the image forming apparatus 9 having the configuration in the Embodiment 1, the image formation is performed in a normal temperature and a normal humidity (23° C., 50% RH) environment, and the difference of the width of the toner image at the center portion and the width of the toner image at the end portion in the print area is evaluated. In addition, as the recording medium, the recording medium having a LTR size and a basis weight of 75 g/m2 is used.

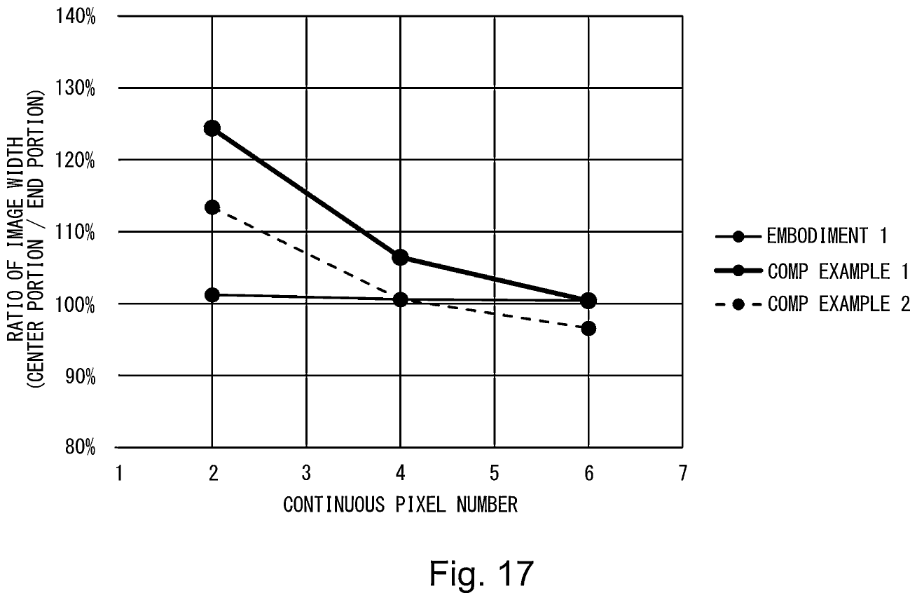

Using FIG. 17, the effects of the Embodiment 1 will be described. A horizontal axis in FIG. 17 represents the continuous pixel number forming the toner image. A vertical axis in FIG. 17 represents the ratio of the image widths at the center portion and at the end portion (center portion=end portion). In FIG. 17, differences of the image widths in three cases are shown: a solid thin line shows results of a case of the Embodiment 1, a solid thick line shows results of a case of a Comparative Example 1, and a broken line shows results of a case of a Comparative Example 2. Configurations and operations of image forming apparatuses in the Comparative Examples 1 and 2 are substantially the same as in the Embodiment 1, except that the image width correcting methods described below are different.

The Comparative Example 1 shows conventional results in which the removal of outer pixel pieces of the outermost pixel is not performed. In a case in which the continuous pixel number is six, the widths of the toner images at the center portion and at the end portion are close, but the difference gets larger as the continuous pixel number gets smaller. The Comparative example 2 shows results in a case in which the removing number of the outer pixel pieces of the outermost pixel is set to “two”, which is a fixed value, regardless of the continuous pixel number. In a case in which the continuous pixel number is four, the widths of the toner images at the center portion and at the end portion are close, but in other cases, there are differences.

The Embodiment 1 is the example in which the removing number of the outer pixel pieces of the outermost pixel are changed depending on the continuous pixel number. Specifically, the removing number is set to four when the continuous pixel number is two, the removing number is set to two when the continuous pixel number is four, the removing number is set to zero when the continuous pixel number is six. In this case, for any continuous pixel numbers, it becomes possible to reduce the difference in the widths of the toner images at the center portion and at the end portion.

As described above, in the Embodiment 1, the number of the removing pixel pieces at the outermost pixel is changed based on the continuous pixel number of the image data. By this, it becomes possible to suppress the difference in the image widths at the center portion and at the end portion regardless of the continuous pixel number of the image data.

Incidentally, in the Embodiment 1, the number of the removing pixel pieces is determined based on a representative value of the light quantity distribution in the scanning direction for the laser scanner, however, the number of the removing pixel pieces may be determined by measuring a characteristic for each scanner.

In addition, in the Embodiment 1, the number of the removing pixel pieces is determined in light of the results of the image widths at the center portion and at the end portion. The removing number at positions between the center portion and the end portion may also be set arbitrarily, and correction for the removing number may be performed depending on a distance from the center portion.

In addition, in the Embodiment 1, based on the light quantity distribution of the laser of the scanner, the regularity of the image widths in the main scanning direction is achieved by performing the removal of the pixel pieces at the outermost pixels of the continuous pixels at the center portion, however, the present invention is not limited thereto. The regularity of the image widths in the main scanning direction may be achieved by performing an addition of the pixel piece to the outermost pixel or further outer pixel of the continuous pixels at the end portion and changing the adding number of the pixel pieces depending on the continuous pixel number.

In addition, in the Embodiment 1, based on the light quantity distribution of the laser of the scanner, the regularity of the image widths in the main scanning direction is achieved by performing the removal of the pixel pieces at the outermost pixels of the continuous pixels at the center portion, however, the present invention is not limited thereto. The regularity of the image widths in the main scanning direction may be achieved by performing the removal of the pixel piece for the pixel inside of the outermost pixels within the continuous pixels as well and changing the number of the removing pixel pieces depending on the continuous pixel number.

Furthermore, in the Embodiment 1, the processing values for the image width correction (number of the removing pixel pieces), characteristic information on the partial magnification, and correcting values for adjusting the light quantity of the light emitting portion 11 (hereinafter referred to as “correcting value, etc.”) are stored in the memory 304 provided in the laser driving portion 300, however, it is not limited thereto. For example, the information such as the correcting value, etc. may be stored in the ROM 102a provided in the image signal generating portion 100, and a location where the correcting value, etc. are stored is not limited. In addition, these correcting value, etc. may be obtained via the CPU bus 103 and the serial communication 113, etc. as appropriate upon executing the various types of the correcting processes. Furthermore, the information such as the correcting value, etc. stored in the memory 304 etc. may be rewritable as appropriate. These are the same in the following Embodiments.

As described above, according to the Embodiment 1, it becomes possible to reduce the difference in the image widths in the scanning direction of the laser even in the case in which the lens having the fθ characteristic is not used.

### Embodiment 2

In the Embodiment 1, as for the difference in the image widths at the center portion and at the end portion caused by the difference in the light quantity of the laser, by changing the number of the removing outer pixel pieces of the outermost pixels based on the continuous pixel number of the image data, it becomes possible to achieve the regularization in a longitudinal direction of the image width. Here, as described above, the image width is determined by the electrostatic latent image formed on the photosensitive drum 4.

Therefore, the image width is also affected by a latent image forming characteristic (sensitivity) of the photosensitive drum 4 in addition to the characteristics of the laser. In an Embodiment 2, an example, which achieves the regularization of the widths of the toner images at the center portion and at the end portion in the longitudinal direction even in cases in which the sensitivities of the photosensitive drum 4 vary, will be described.

Basic configurations and operations of an image forming apparatus in the Embodiment 2 are the same as those in the Embodiment 1. Therefore, elements having the same or corresponding functions and configurations as in the Embodiment 1 are marked with the same reference numerals and detailed description thereof will be omitted. Matters not specifically described here in the Embodiment 2 are the same as in the Embodiment 1.

### <Sensitivity of the Photosensitive Drum 4>

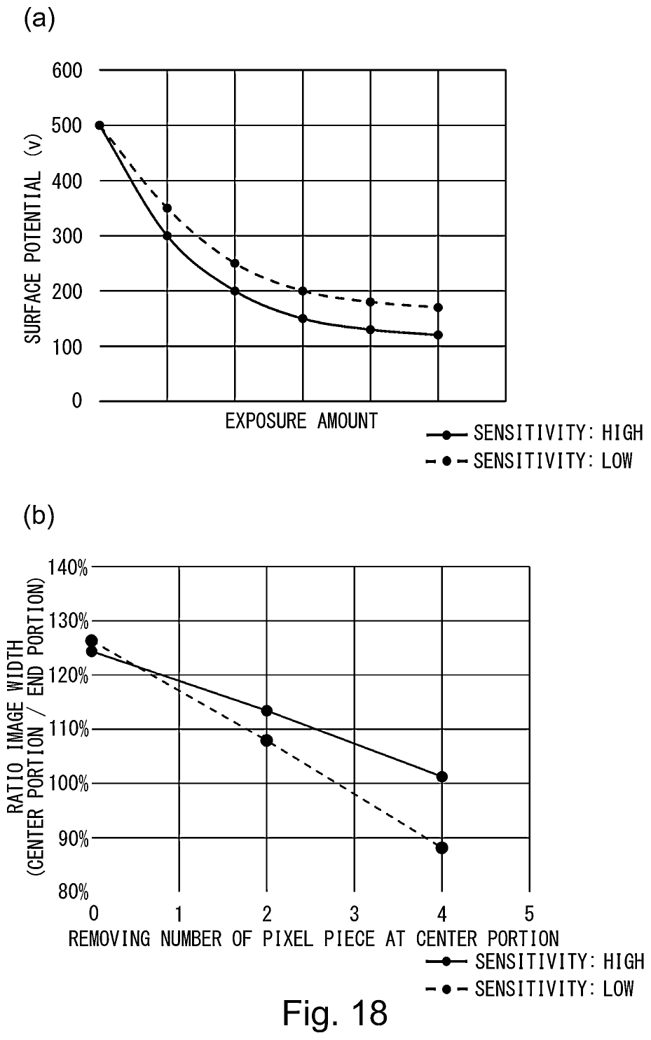

Part (a) of FIG. 18 is a view for describing difference in the sensitivities of the photosensitive drum 4. A horizontal axis represents the light quantity (exposure amount) of the laser, and a vertical axis represents surface potential (V) of the photosensitive drum 4.

A solid line in part (a) of FIG. 18 represents transition of the surface potential in a case in which the sensitivity of the photosensitive drum 4 is high, and a broken line in part (a) of FIG. 18 represents transition of the surface potential in a case in which the sensitivity of the photosensitive drum 4 is low.

When the exposure is performed with the same light quantity of the laser, the photosensitive drum 4 with higher sensitivity has a lower surface potential than the photosensitive drum 4 with lower sensitivity, and a wider electrostatic latent image is formed. As a result, the image width becomes thicker on the photosensitive drum 4 with higher sensitivity.

Part (b) of FIG. 18 is a view for describing effect of the image width correcting process on the regularity of the image width in the scanning direction when the photosensitive drums 4 with different sensitivities are used. A horizontal axis represents the number of the removing pixel pieces at the center portion of the image width correcting process. A vertical axis represents the ratio of the image widths at the center portion and the end portion (center portion:end portion) when the continuous pixel number is two.

A solid line represents results of the image width ratio in a case in which the photosensitive drum 4 with high sensitivity is used, and a broken line represents results of the image width ratio in a case in which the photosensitive drum 4 with low sensitivity is used. The photosensitive drum 4 with high sensitivity has a smaller difference in the image widths at the center portion and at the end portion when the number of the removing pixel pieces is four, which is the same as shown in the Embodiment 1. On the other hand, when the photosensitive drum 4 with low sensitivity is used, the image width at the center portion is thinner than the image width at the end portion when the number of the removing pixel pieces is four. This is because when the removing of the pixel pieces are performed for the photosensitive drum 4 with low sensitivity, since the light quantity at the end portion in a light emitting area is lowered, it becomes more difficult for the electrostatic latent image to be formed on the photosensitive drum 4 with low latent image forming characteristic. In this case, by setting the removing pixel pieces to three, it becomes possible to reduce the difference in the image widths at the center portion and at the end portion.

In the Embodiment 2, the number of the removing pixel pieces is corrected based on the sensitivity information of the photosensitive drum 4. Specifically, if the sensitivity characteristic of the photosensitive drum 4 is lower than a specified value, a correction in which the number of the removing pixel pieces is reduced by one is performed. Incidentally, in the example described above, an example, in which the image widths at the center portion and at the end portion are regulated when the sensitivity of the photosensitive drum 4 is low, is described. Contrary to the example described, if the sensitivity characteristic of the photosensitive drum 4 is even higher, the number of the removing pixel pieces may be increased.

In the Embodiment 2, in light of the relationship between the number of the removing pixel pieces and the image width in the image width correcting process described above, the removing method of the pixel pieces in the image width correcting process is changed based on the continuous pixel number and the sensitivity of the photosensitive drum 4. Incidentally, in the Embodiment 2, information on the sensitivity characteristic of the photosensitive drum 4 is written into the memory 4a for the photosensitive drum 4, and the correction is performed based on this information.

### <Control Related to Settings for the Image Width Correcting Process>

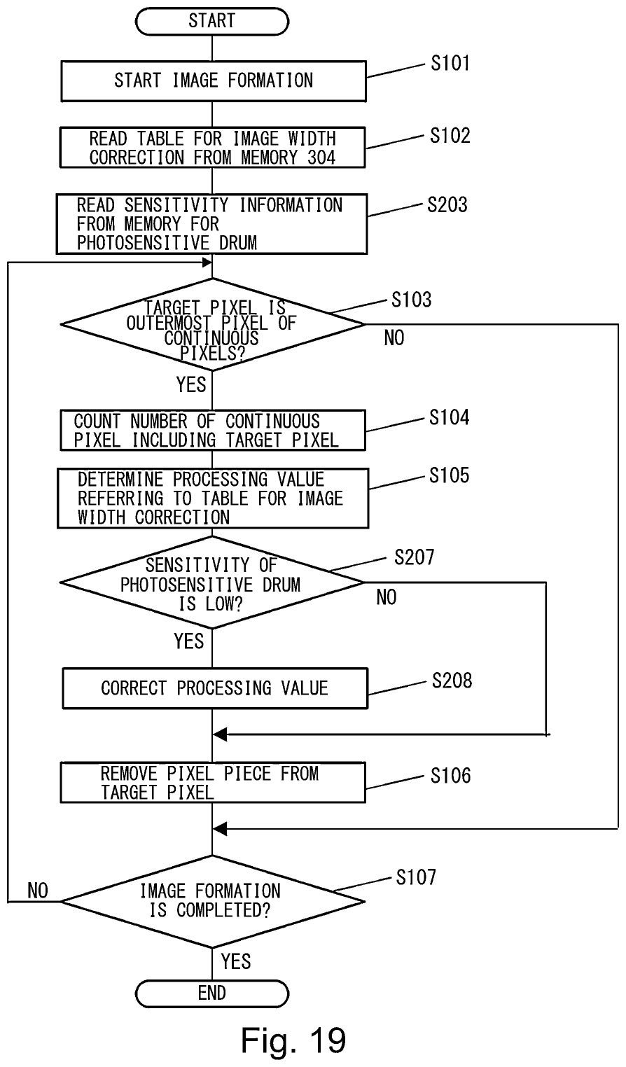

FIG. 19 is a flowchart illustrating a method of the image width correcting process in the Embodiment 2. Incidentally, since the processes of S201 and S202 are the same as those of S101 and S102 in FIG. 16, description thereof will be omitted. Here, processing values read in S202 are stored in the image modulating portion 101. In the Embodiment 2, as in the Embodiment 1, the processing values for the image width correction are stored in the memory 304 in the table format shown in Table 1.

In S203, the control portion 1 performs reading of the sensitivity information of the photosensitive drum 4 from the memory 4a for the photosensitive drum 4. Incidentally, since the processes of S204 through S206 are the same as the those of S103 through S105 in FIG. 16, description thereof will be omitted. In S207, the control portion 1 determines whether or not the sensitivity of the photosensitive drum 4 is low based on the sensitivity information of the photosensitive drum 4 read in S203. In S207, if the control portion 1 does not determine that the sensitivity of the photosensitive drum 4 is low, then proceeds the process to S209.

That is, the control portion 1 uses the correcting value determined in S206 without the correction. In S207, if the control portion 1 determines that the sensitivity of the photosensitive drum 4 is low, then proceeds the process to S208. In S208, the control portion 1 performs correction of the correcting value determined in S206. Since the processes of S209 and S210 are the same as those of S106 and S107 in FIG. 16, description thereof will be omitted.

According to the flowchart described above, it becomes possible to regulate the widths of the toner images at the center portion and at the end portion by changing (correcting) the number of the removing pixel pieces of the outermost pixels in the continuous pixels based on the sensitivity characteristic of the photosensitive drum 4. In the Embodiment 2 described above, the example in which the sensitivity characteristic of the photosensitive drum 4 are classified into two categories and the number of the removing pixel pieces is changed based on the classification is described, however, it is not limited to this configuration. For example, by classifying the sensitivity characteristic of the photosensitive drum 4 in more detail, the number of the removing pixel pieces may be finely changed to achieve further regularization of the widths of the toner images at the center portion and at the end portion.

As described above, according to the Embodiment 2, it becomes possible to reduce the difference in the image widths in the scanning direction of the laser even in the case in which the lens having the fθ characteristic is not used.

### Embodiment 3

In the Embodiment 2, as for the difference in the image widths at the center portion and at the end portion caused by the difference in the sensitivity of the photosensitive drum 4, by changing the number of the removing pixel pieces of the outermost pixels in the continuous pixels based on the sensitivity information of the photosensitive drum 4 stored in the memory 4a, the widths of the toner images at the center portion and at the end portion are regulated. Here, the sensitivity characteristic of the photosensitive drum 4 may change depending also on a usage history of the photosensitive drum 4 and a usage environment of a main body. In the Embodiment 3, an example, in which the number of the removing pixel pieces is changed based on information on the usage history of the photosensitive drum 4 and the usage environment of the main body, will be described. Incidentally, the information on the usage environment includes, for example, temperature and humidity, which can be detected by the environment sensor 200. Basic configurations and operations of the image forming apparatus in the Embodiment 3 are the same as those in the Embodiment 1. Therefore, elements having the same or corresponding functions and configurations as in the Embodiment 1 are marked with the same reference numerals and detailed description thereof will be omitted.

### <The Sensitivity of the Photosensitive Drum and the Usage History and the Usage Environment>

It is known that the sensitivity of the photosensitive drum 4 changes depending also on the usage history and the usage environment. As for the photosensitive drum 4 used in the Embodiment 3, the sensitivity of the photosensitive drum 4 is deteriorated when the photosensitive drum 4 has many usage history since the surface of the photosensitive drum 4 is scraped and a film thickness gets thinner. In addition, the sensitivity of the photosensitive drum 4 is improved when the temperature of the usage environment of the image forming apparatus 9 is high.

As shown in the Embodiment 2, when the sensitivity of the photosensitive drum 4 changes, the relationship between the widths of the toner images at the center portion and at the end portion changes. Therefore, in order to regulate the widths of the toner images at the center portion and at the end portion, the number of the removing pixel pieces may be corrected by acquiring the information which may change the sensitivity of the photosensitive drum 4.

As for the photosensitive drum 4 used in Embodiment 3, in a case in which the photosensitive drum 4 is used for more than half of an expected lifetime thereof (longer than a predetermined lifetime), by increasing a correction amount for the number of the removing pixel pieces, the widths of the toner images at the center portion and at the end portion are regulated. In addition, in a case in which the temperature of the usage environment of the image forming apparatus 9 is 28° C. or higher (above a predetermined temperature), by reducing the correction amount for the number of the removing pixel pieces, the widths of the toner images at the center portion and at the end portion are regulated.

In the Embodiment 3, by using a usage correction table shown in Table 2, the number of removing pixel pieces set in the Embodiment 1 is corrected when the usage history of the photosensitive drum 4 and the temperature of the usage environment are different from assumption.

TABLE 2

| | Usage history | |
|---|---|---|
| | is half of the | |
| Conditions for the | expected lifetime | Usage environment is |
| correction | or more | 28° C. or higher |
| Correction amount for the | −1 | +1 |
| number of the removing | | |
| pixel pieces | | |

Here, a first row of Table 2 shows conditions for the correction (usage history and temperature of the usage environment), and a second row shows the correction amount (−1 (subtracts a predetermined value), +1 (adds a predetermined value)) for the number of removing pixel pieces.

In the Embodiment 3, in light of the relationship between the number of the removing pixel pieces in the image width correcting process and the image width described above, the removing method of the pixel pieces in the image width correcting process is changed based on the continuous pixel number, the usage history and the usage environment. Incidentally, in the Embodiment 3, the usage history of the photosensitive drum 4 and the temperature information of the usage environment are referred, and the control is performed based on the information.

### <Control Related to the Settings for the Image Width Correcting Process>

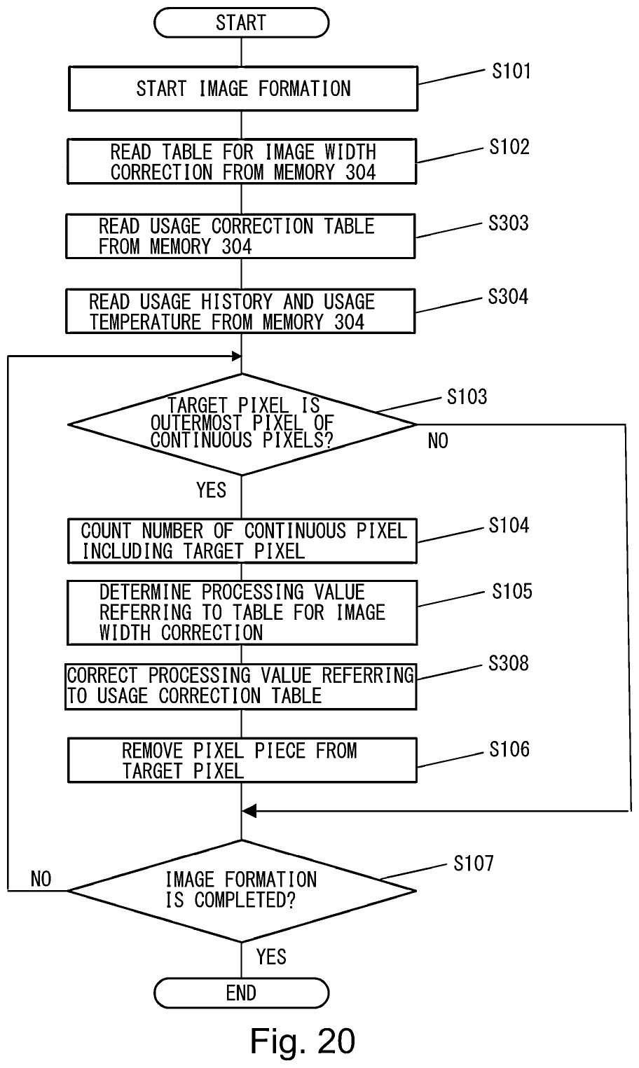

FIG. 20 is a flowchart illustrating a method of the image width correcting process in the Embodiment 3. Incidentally, since processes of S301 and S302 are the same as those of $101 and S102 in FIG. 16, description thereof will be omitted. In the Embodiment 3, as in the Embodiment 1, the processing values for the image width correction are stored in the memory 304 in the table format shown in Table 1. In S303, the control portion 1 reads the usage correction table (Table 2) from the memory 304. In S304, the control portion 1 reads the usage history and the information on the usage temperature of the photosensitive drum 4 from the memory 4a. In the Embodiment 3, the usage correction table is stored in the memory 304 in the table format shown in Table 2. Since the processes of S305 through S307 are the same as those of S103 through S105 in FIG. 16, description thereof will be omitted.

In S308, the control portion 1 refers to the usage correction table read in S303 and corrects the processing value. For example, based on the information read in S304, if the usage history of the photosensitive drum 4 is half of the expected lifetime or more (the lifetime is 50% or less), the control portion 1 subtracts one (−1) from the processing value determined in S307. In addition, for example, based on the information read in S304, if the temperature of the usage environment of the photosensitive drum 4 is 28° C. or higher, the control portion 1 adds one (+1) to the processing value determined in S307. Since the processes of S309 and S310 are the same as those of S106 and S107 in FIG. 5, description thereof will be omitted.

According to the flowchart described above, by changing the number of the removing pixel pieces of the outermost pixels in the continuous pixels based on the usage history and information on the temperature of the usage environment, it becomes possible to regulate the widths of the toner images at the center portion and at the end portion. In the Embodiment 3 described above, an example, in which threshold values (e.g., 50% or 28° C.) are set for the usage history and the temperature of the usage environment of the photosensitive drum 4 and the number of the removing pixel pieces is corrected when the threshold value is exceeded, is described, however, it is not limited to the configuration. For example, by classifying items related to the usage history and the usage temperature of the photosensitive drum 4 in detail, the number of the removing pixel pieces may be finely changed to achieve further regularization of the widths of the toner images at the center portion and at the end portion. In addition, further correction for the number of the removing pixel pieces, which are set based on the sensitivity information of the photosensitive drum 4 used in the Embodiment 2, may be performed by referring to the usage correction table in the Embodiment 3.

As described above, by correcting the removing number of the pixel pieces according to condition in which the sensitivity of the photosensitive drum 4 changes, it becomes possible to further regularization of the widths of the toner images at the center portion and at the end portion.

### (About Humidity)

The usage environment of the photosensitive drum 4 may be humidity. When the humidity in the usage environment gets lower, the surface potential of the photosensitive drum 4 after the charging gets higher. As a result, the surface potential on the surface of the photosensitive drum 4 after the exposure with the laser light gets higher. Therefore, in a case in which the humidity in the usage environment is low compared to a case in which the humidity is high, the image width formed on the photosensitive drum 4 gets thinner. In other words, the difference in the image widths at the center portion and at the end portion in the scanning direction gets smaller when the light quantity is changed. Therefore, it becomes necessary for the control portion 1 to reduce the number of the removing pixel pieces of the outermost pixels in the continuous pixels in the case in which the humidity is low compared to the case in which the humidity is high. In light of this situation, for example, as for the usage correction table in Table 2, conditions for the correction on the humidity of the usage environment may be added, and if the humidity in the usage environment is a threshold value or lower (predetermined humidity or lower), for example, “−1” may be calculated to (subtracts the predetermined value from) the correction amount.

As described above, according to the Embodiment 3, it becomes possible to reduce the difference in the image widths in the scanning direction of the laser even in the case in which the lens having the fθ characteristic is not used.

### OTHER EMBODIMENTS

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-183782 filed on Oct. 26, 2023, which is hereby incorporated by reference herein in its entirety.

What is claimed is:

1. An image forming apparatus comprising:
a rotatable photosensitive member; and
a light emitting means configured to form a latent image on the photosensitive member by scanning laser light based on image data in a scanning direction,
wherein a scanning speed which is a speed of the laser light scanned on the photosensitive member is slower at a center portion than at an end portion, and
a correcting means configured to correct the image data according to a continuous pixel number which is a number of pixels, for forming the latent image, continued in the scanning direction and a pixel position which is a position within continuous pixels which are a plurality of pixels continued.

2. An image forming apparatus according to claim 1, wherein the correcting means performs correction to a center portion of the image data in the scanning direction.

3. An image forming apparatus according to claim 1, wherein the correcting means corrects the image data by changing a width corresponding to one pixel in the image data.

4. An image forming apparatus according to claim 1, wherein the correcting means changes a correction amount in correcting the image data depending on whether the pixel position is an end or an inside of the continuous pixels.

5. An image forming apparatus according to claim 1, wherein the correcting means changes a correction amount in correcting the image date so as to increase as the scanning speed is slow.

6. An image forming apparatus according to claim 1, wherein the correcting means changes a correction amount in correcting the image date so as to increase as the continuous pixel number is small.

7. An image forming apparatus according to claim 1, wherein the correcting means changes a correction amount in correcting the image data based on a distribution of a light quantity of the laser light in the scanning direction.

8. An image forming apparatus according to claim 7, wherein the correcting means changes the correction amount so as to increase as the light quantity is large.

9. An image forming apparatus according to claim 1, wherein the correcting means changes a correction amount in correcting the image data depending on a sensitivity of the photosensitive member.

10. An image forming apparatus according to claim 9, wherein the correcting means changes the correction amount in correcting the image data so as to increase as the sensitivity of the photosensitive member is high.

11. An image forming apparatus according to claim 1, wherein the correcting means changes a correction amount in correcting the image data based on a usage history of the photosensitive member.

12. An image forming apparatus according to claim 11, wherein the correcting means subtracts a predetermined value from the correction amount in correcting the image data in a case in which a lifetime of the photosensitive member is longer than a predetermined lifetime.

13. An image forming apparatus according to claim 1, wherein the correcting means changes a correction amount in correcting the image data based on a usage environment of the image forming apparatus.

14. An image forming apparatus according to claim 13, wherein the usage environment is a temperature, and
wherein the correcting means adds a predetermined value to the correction amount in correcting the image data in a case in which the temperature is a predetermined temperature or higher.

15. An image forming apparatus according to claim 13, wherein the usage environment is a humidity, and
wherein the correcting means subtracts a predetermined value to the correction amount in correcting the image data in a case in which the humidity is a predetermined humidity or lower.
